(19) United States
(12) Patent Application Publication
(10) Pub. No.: US 2019/0258325 A1
(43) Pub. Date: Aug. 22, 2019

(54) MID-AIR FINGER POINTING DETECTION FOR DEVICE INTERACTION

(71) Applicant: The Hong Kong University of Science and Technology, Kowloon, Hong Kong (CN)

(72) Inventors: Pan HUI, New Territories, Hong Kong (CN); Farshid Hassani Bijarbooneh, New Territories, Hong Kong (CN); Lik Hang LEE, Kowloon, Hong Kong (CN)

(21) Appl. No.: 16/346,098

(22) PCT Filed: Oct. 26, 2017
(86) PCT No.: PCT/CN2017/107832

§ 371 Date: Apr. 29, 2019

Related U.S. Application Data
(60) Provisional application No. 62/496,854, filed on Nov. 1, 2016.

(51) Int. Cl. G06F 3/03; G06F 3/01; G06F 3/0481; G06F 3/0482; G06F 3/0484

(52) U.S. Cl. CPC G06F 3/0304; G06F 3/017; G06F 3/04842; G06F 3/04817; G06F 3/0482; G06F 3/04812

(57) ABSTRACT

The technology described herein is generally directed towards a free hand, barehanded technique to provide user input to a device, such as to move a cursor on a user interface. Frames of images are captured, and each frame is processed to determine a fingertip position. The processing includes an image segmentation phase that provides a binary representation of the image, a disjoint union arborescence graph construction phase that operates on the binary representation of the image to construct set of arborescence graphs, and a fingertip location estimation phase that selects a graph from among the set of arborescence graphs and uses the root node to estimate the fingertip location. Also described is determining a hand orientation from the set of arborescence graphs.

### CROSS REFERENCE TO RELATED APPLICATION

This application claims priority to U.S. Provisional Application No. 62/496,854, filed on Nov. 1, 2016, entitled: “FingerPoint: towards non-intrusive mid-air interaction for smart glass,” the entirety of which application is hereby incorporated herein by reference.

### TECHNICAL FIELD

This disclosure generally relates to sensing user interaction with a device, including via mid-air detection of a pointed finger.

### BACKGROUND

A number of wearable computing devices, such as smart watches and smart glasses, have recently emerged in high-tech commercial products. The size of these devices continues to shrink, such that eventually the hardware interface elements such as buttons, touchpads, and touch screens will be phased out, at least to a significant extent.

For example, smart glasses are convenient because among other features they can display virtual content including augmented information. However, interaction with smart glasses is relatively encumbered and problematic. For one, the virtual content on the display is not touchable, and thus direct manipulation can be a fatiguing and error-prone task. For another, compared to a smartphone, contemporary smart glasses have other challenging issues, such as reduced display size, a small input interface, limited computational power, and short battery life.

The available input methods of smart glasses limit the effectiveness of their interaction. One such device requires users to interact through a separate, tangible handheld device. Another relies on voice commands as the input source, which is often inappropriate or inconvenient, such as in public areas when user privacy is an issue or when issuing voice commands is socially inappropriate or difficult because of too much noise. Yet another smart glasses device includes a mini-trackball that provides a small area for tap and click, however, the current input options on the small area of the mini-trackball can trigger unwanted operations, such as inadvertent clicks, and inadvertently sensed double-taps when successive single taps are intended.

Another solution for device input sensing is gesture detection which operates by having users wear specialized instrumental gloves and/or other sensors. However with this solution users need to hold or wear additional apparatus/markers or body attachments. Gesture detection via depth cameras is yet another option for device input sensing, however depth cameras are generally unavailable in commercial products, generally because their additional cost makes devices such as smart glasses less attractive to consumers as well as manufacturers.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, one or more aspects of the technology described herein are directed towards processing image data into a fingertip location. Aspects include processing camera image data corresponding to a captured image comprising a hand with a pointed finger. The processing comprises performing image segmentation on the camera image data to obtain segmented image data that distinguishes pixels of the hand with the pointed finger from other pixels, and scanning the segmented image data using a sliding window, comprising using the sliding window at a current position to determine whether a first value of a pixel within the sliding window at the current position satisfies a selection criterion for the hand with the pointed finger. In response to the selection criterion being determined to be satisfied, aspects include adding a vertex node representing the pixel to a graph set and performing a search for one or more other nodes of the graph set related to the vertex node. In response to the selection criterion being determined not to be satisfied, and until each position of the sliding window is used, other aspects include using the sliding window at another position to determine whether a next value of a next pixel within the sliding window at the other position satisfies the selection criterion. Aspects include estimating a location of a fingertip of the hand with the pointed finger comprising identifying a selected graph from the graph set based on a number of nodes relative to other graphs in the graph set, and obtaining the location of the fingertip as a function of a root node of the selected graph.

Other advantages may become apparent from the following detailed description when taken in conjunction with the drawings.

### BRIEF DESCRIPTION OF THE DRAWINGS

The technology described herein is illustrated by way of example and not limited in the accompanying figures in which like reference numerals indicate similar elements and in which:

FIG. 1 is an example block diagram representation of a device configured to determine and use a fingertip position for user input, according to one or more example implementations.

FIG. 2 is an example representation of gestural control for cursor movement through freehand mid-air fingertip detection, according to one or more example implementations.

FIG. 3 is an example representation of gestural control for cursor movement and a corresponding range of interaction in front of a camera of a device, according to one or more example implementations.

FIGS. 4 and 5 are example block diagram representations of logic and data structures used to estimate a fingertip location, according to one or more example implementations.

FIGS. 6 and 7 are example representations of sliding windows used for detecting fingertip location within an image, according to one or more example implementations.

FIG. 8 is a flow diagram representing example operations for processing image data into fingertip coordinates, according to one or more example implementations.

FIG. 9 is a flow diagram representing example operations of an image segmentation phase, according to one or more example implementations.

FIGS. 10-13 comprise a flow diagram representing example operations of a graph construction phase, according to one or more example implementations.

FIG. 14 illustrates a block diagram of a computing system operable to execute the disclosed systems and methods in accordance with one or more example implementations.

### DETAILED DESCRIPTION

Various aspects of the technology described herein are generally directed towards image capturing and processing that allows users to perform barehanded, mid-air pointing operations to locate target objects. The technology leverages the natural human instinctive ability to pinpoint objects.

In one or more aspects, a user's hand and fingertip can be captured within an image by a monocular camera, such as the camera embedded in smart glasses (or other suitable devices). The image data may then be processed into a fingertip location. For example, a cursor displayed within a projected display may be moved according to the currently camera-captured and computed fingertip location of a user; when the cursor is moved to a desired target position, the user can further instruct the hardware interface (e.g., by tapping on a touch pad or mini-trackball) to select a target object such as an icon or the like underlying the cursor. A mid-air tap for selection or the like also may be detected.

As will be understood, the technology provides a non-intrusive, seamless, mid-air interaction technique, including for human-smart glasses interaction without any additional ambient sensor(s) and/or instrumental glove. Indeed, the technology described herein has been successfully implemented on Google Glass™ version 1.0 (CPU with 1.2 GHz Dual Core, 1.0 GB RAM, 16 GB storage capacity, 5-megapixel camera, and 570 mAH battery life; operating system Android 4.4.0) and Mad Gaze (CPU with 1.2 GHz Quad Core, 512 MB RAM, 4 GB storage capacity, 5-megapixel camera, and 370 mAH battery life; operating system Android 4.2.2; see http://madgaze.com/ares/specs). One or more implementations of the described technology achieve an average of twenty frames per second, which is higher than the minimal requirements of real-system interaction, (performing 1.82 times faster than the interaction on the hardware interface), while only consuming an additional 14.18 percent of energy and occupying only 19.30 percent of the CPU resource.

It should be understood that any of the examples herein are non-limiting. For example, implementations of the fingertip pointing/location detection are shown herein as incorporated into smart glasses device, however other devices having cameras may benefit from the technology described herein, including smartphones, smart televisions, monitors with cameras, and the like. As such, the technology described herein is not limited to any particular implementations, embodiments, aspects, concepts, structures, functionalities or examples described herein. Rather, any of the implementations, embodiments, aspects, concepts, structures, functionalities or examples described herein are non-limiting, and the technology may be used in various ways that provide benefits and advantages in user interaction detection in general.

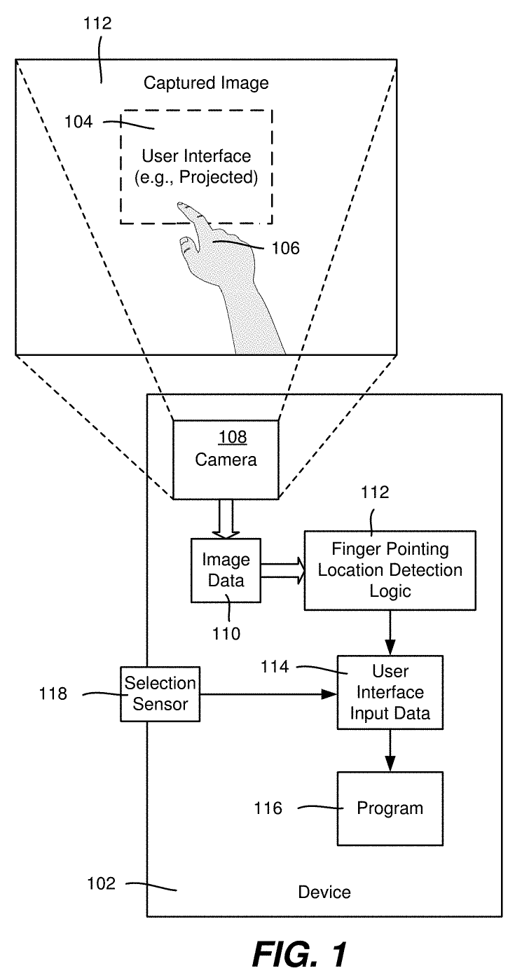

In general and as represented in the example of FIG. 1, a device 102 includes a user interface 104, such as a “heads-up” display projected via a smart glasses device. A user manually points in the air, as represented by the depicted hand and finger 106, to an element displayed on the user interface 104. A device camera 108, which may be a conventional monocular camera built into the device 102, captures camera frames of image data 110 including of the user's hand and finger 106 along with background imagery, shown via the captured image 112; (note that ordinarily, the camera 108 does not capture the projected image, as that is only visible to the user).

The resulting image data 110 is processed via finger pointing location detection logic 112 as described herein into user interface input data 114 such as x- and y-coordinates of the estimated fingertip location. A program 116 such as an operating system or application consumes the data 114 whereby a user interface cursor or the like is able to be moved within the user interface 104 as the user changes his or her fingertip location. A selection sensor 118, such as a contact sensitive touchpad, a proximity sensor, or other suitable sensor causes other user interface input data 114 when the selection sensor 114 is actuated; (note that any type of selection sensor may be used, including selection based on sound, gesture, companion device input and others). In this way, for example, at the time of sensor actuation, the fingertip coordinates may be mapped to an input object (e.g., represented by an icon that appears on the projected display), whereby selection of that object is made by the user; once an application program is running, user input to that application program may be similarly obtained.

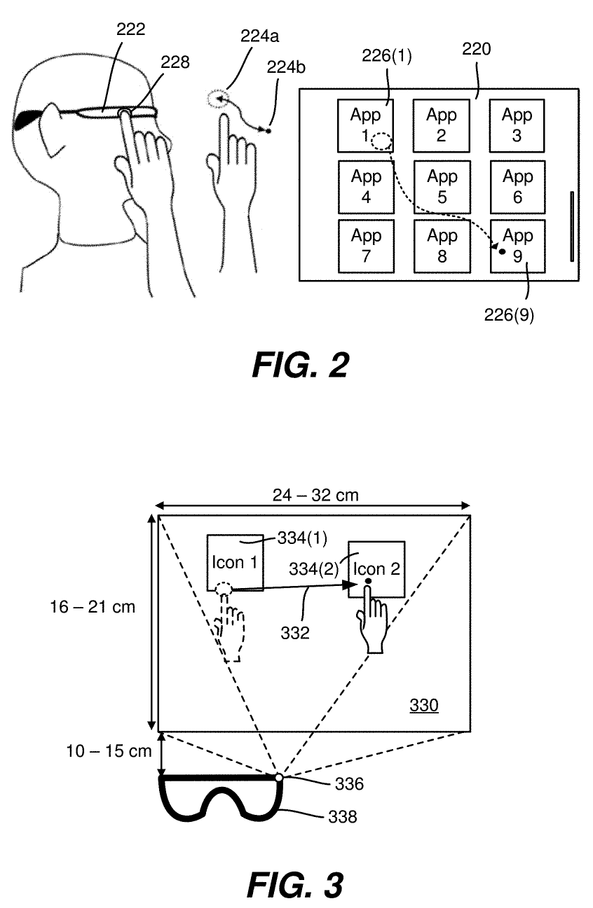

FIG. 2 represents example movement of a finger in mid-air that translates to cursor movement on a user interface display 220. A user sees the user interface display 220 via the smartglasses device 222, and moves (in this example the left index finger's fingertip) from a first mid-air location 224a to a second mid-air location 224b. This fingertip movement is captured and processed as described herein, resulting in cursor movement from an icon 226(1) representing an application program (App1) to an icon 226(9) representing an application program (App9). A user may launch this application program App(9) by way of actuating a sensor 228 (e.g., appropriately tapping on the smartglasses device 222) when the cursor is position over the icon 226(9).

FIG. 3 shows an example of gestural control for cursor movement and the corresponding range of interaction in front of a camera of a device. As can be seen, the fingertip of a user's finger becomes a distinctive feature in the interaction, and is simultaneously mapped with a mouse-like cursor (or other pointing indicator) in the interface 330. The swiping of the fingertip (shown via the arrow 332) drives the movement of the cursor from icon 1, labeled 334(1), to icon 2, labeled 334(2). To this end, as described herein, the fingertip is detected and tracked by the monocular camera 336 on the body of the smartglasses 338. In this example, the user moves his or her left hand freely in three dimensional space, which enables mid-air interaction to be acted in a comfortable and natural posture. In this example, the moving hand is positioned in front of the camera with the distance ranging approximately from 10 to 15 centimeters. The user's hand movements are kept to a minimum, which range from approximately 24 to 32 centimeters horizontally and approximately 16 to 21 centimeters vertically.

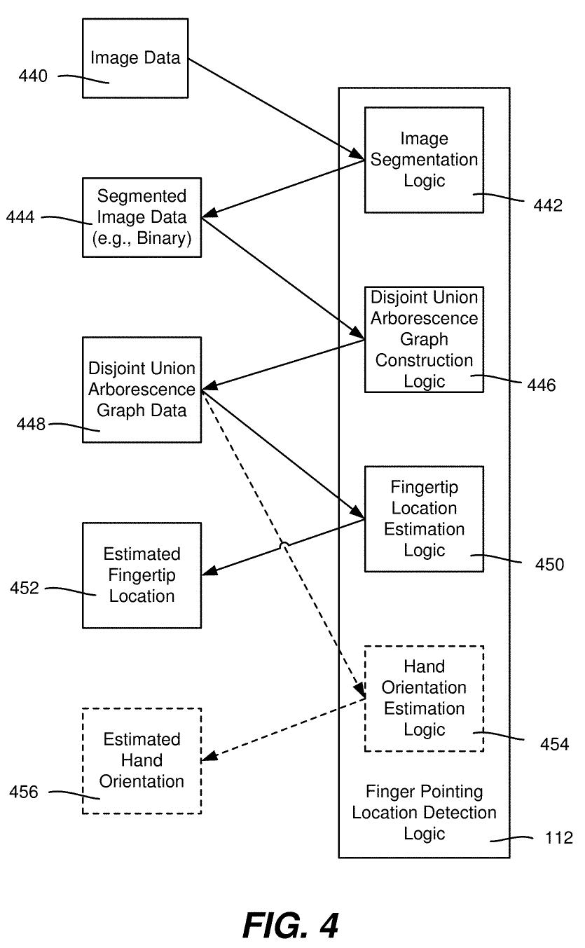

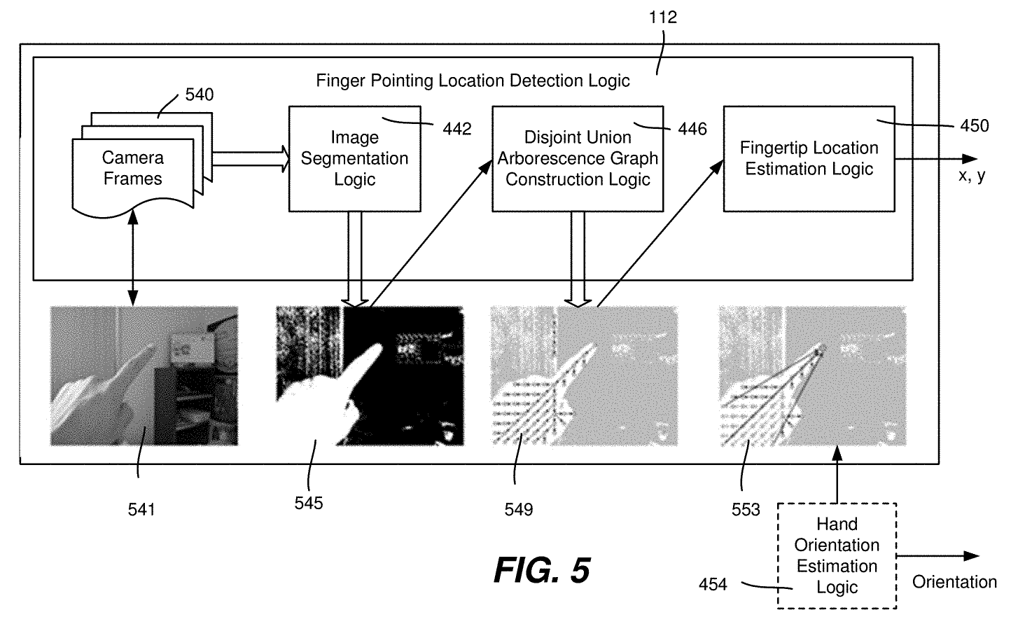

Turning to aspects related to determination of the fingertip location, FIGS. 4 and 5 show an example implementation for fingertip location that is based on an image segmentation phase, a disjoin union arborescence construction phase, and a fingertip location estimation phase. These phases are shown in FIG. 4 with various resultant data structures, and in FIG. 5 with corresponding representations of the data processing as applied to an image frame.

In FIG. 4, image data 440, shown as camera frames 540 in FIG. 5, are output by the device camera 108 of FIG. 1, e.g., at the rate of 20 frames per second. One such frame is represented by the image 541 of FIG. 5. In one or more implementations, this captured image data is first processed via the image segmentation phase.

In the image segmentation phase, image segmentation logic 442 converts the image from its standard color space into a space/model that is more suitable for processing. For example, in one or more example implementations, the image segmentation logic 442 converts Android standard color space (YUV420sp) to the HSV (hue-saturation-value color) model. The image segmentation logic 442 then applies a threshold to extract skin tone color and returns a binary image (array), shown as segmented image data 444 in FIG. 4 and as the binary image 545 in FIG. 5.

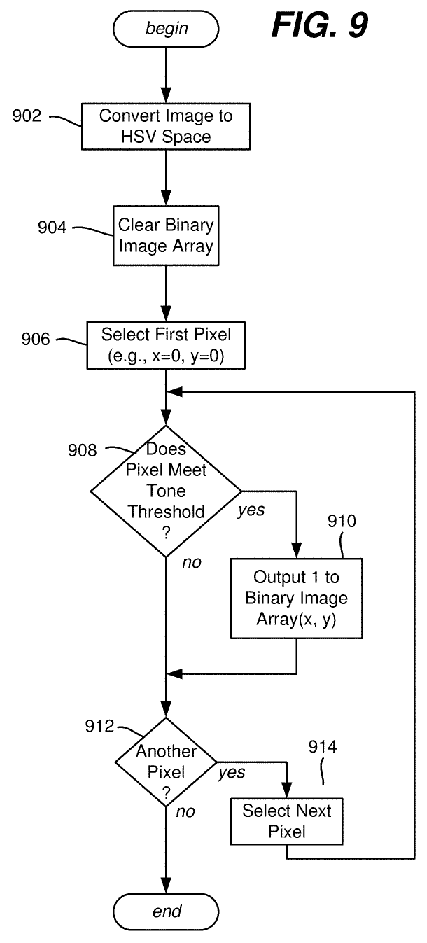

To this end, denote the output of the image segmentation with the binary function $I(x,y) in {0,1} such that 0<=x<W, 0<=y<H, where W and H represent the width and height of the image, respectively. The binary function I(x,y)=1 if and only if the pixel at location (x,y) belongs to the skin tone and I(x,y)=0 otherwise. Note that the skin tone threshold may be calibrated on a per-user and/or per-group basis for different user skin tones. Additional description of the image segmentation phase/logic is described herein with reference to FIG. 9.

To remove artifacts from the resulting threshold image 545, morphological transformations may be used in certain implementations. However, morphological operations (particularly opening and closing) are unpractical for the limited computational power of conventional smart glasses. Therefore, described herein is a filter method that removes and artifacts, with the output used in the construction of the disjoint union arborescence in a next phase.

In a next processing phase in this example, disjoint union arborescence construction logic 446 builds arborescence graphs (shown as disjoint union arborescence graph data 448 in FIG. 4 with a “mapped graph” representation 549 in FIG. 5) to represent paths in the binary image corresponding to pixels that met the skin tone threshold. Note that in graph theory, an arborescence graph is a directed acyclic graph where there is only one path from the root node to every other node in the graph. Let A(V,E) represent the arborescence graph with the set of vertices V and the set of edges E. Let the set DA={A₁(V,E), A₂(V,E), . . . , Aₘ(V,E)} denote a set of m arborescence graphs where the set of vertices for any two arborescence graph in DA is disjoint. The set DA is referred to herein as the disjoint union arborescence set. The technology described herein creates an efficient data structure for the set DA to be constructed from I(x, y). A node vx;y belongs to an arborescence graph A(V,E) according to the following criteria:

v_{(x,y)} ∈ V⇔∀(i. j) ∈ F, I(x+i, y+j)=1 (1)

where F is set of coordinates that defines a filter of size S as follows:

F={(i,j)|i=0∧0≤j<S}∪{(i,j)|j=0∧0≤i<S} (2)

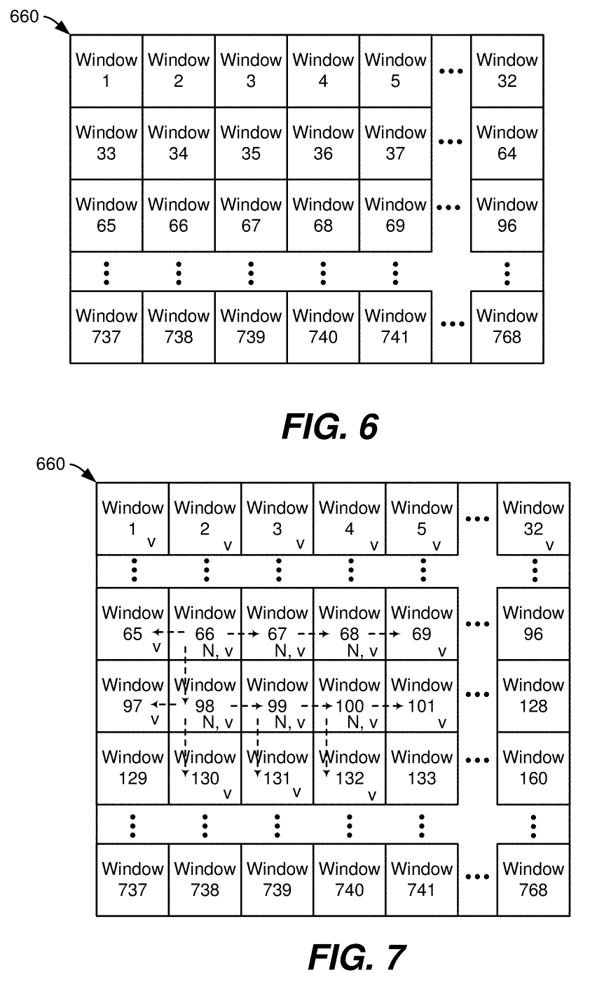

As represented in FIGS. 6 and 7, the image I(x, y) (labeled 660) is scanned by the disjoint union arborescence construction logic 446 using a sliding window of size S. For each sliding window the condition in the equation (1) is applied to the pixel at the center of the window. If the vertex vx;y is chosen for the set, then a new arborescence graph is added to the set DA and a recursive breadth first search is initiated to direct the sliding window on the neighboring windows where there is a potential new node, as represented by the dashed arrows in FIG. 7 (where an “N” in a window such as the window 66 indicates that a graph node is added to the set). In one or more implementations, the breadth first search only moves the sliding window on the same scan line or the line below because the image is scanned from the top row to the bottom row.

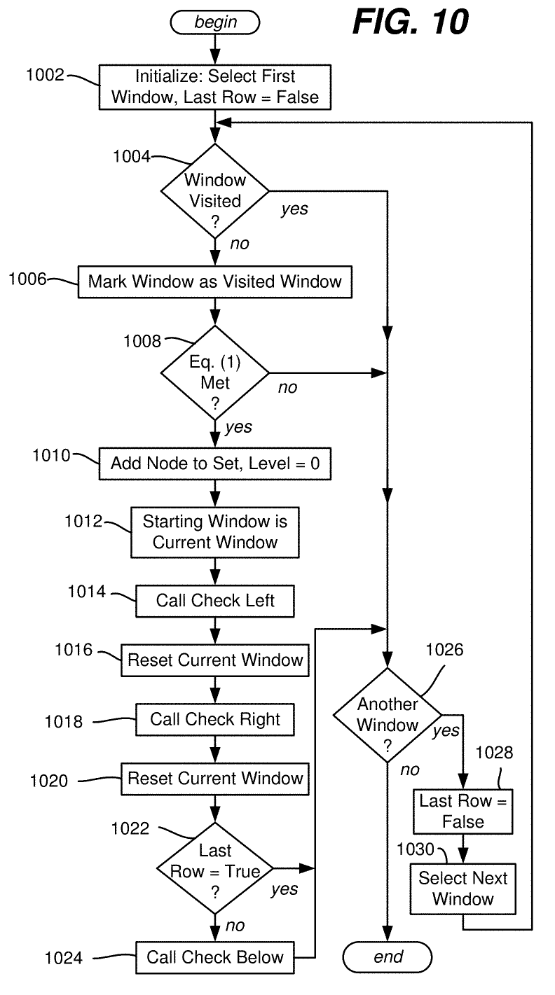

During the breadth first search operation the algorithm incrementally marks the depth of each node and updates the number of nodes belonging to each depth level. The algorithm also marks the visited sliding windows (shown via a “v” in some of the windows in FIG. 7) so that they will not be visited again in future scans. As a result, the image is scanned in linear time based on the size of the sliding windows which determines their number; (for example, for an image of size 320*240 and a filter size S=10 there are 32*24=768 sliding windows). Additional description of the disjoint union arborescence construction phase/logic is described herein with reference to FIGS. 10-13.

It should be noted that in the above example, the window/filter size is the same in both the horizontal and vertical horizontal and vertical. However it is understood that the window/filter size may have different horizontal and vertical dimensions.

In a fingertip location estimation phase 450 (FIGS. 4 and 5), the data structure representing the set DA, along with the depth level of each node and the number of nodes at any given depth, are processed. In this phase the algorithm selects the arborescence graph with the largest number of nodes from the set DA, and determines that the fingertip is located at the root node of the selected graph.

In an optional operation, the hand orientation also may be computed. To this end, Hand Orientation Estimation Logic 454 (FIG. 4) chooses the nodes on the longest path from the root node in the graph, and finds the vector that connects the root node to them, as generally represented in FIG. 5 by block 553.

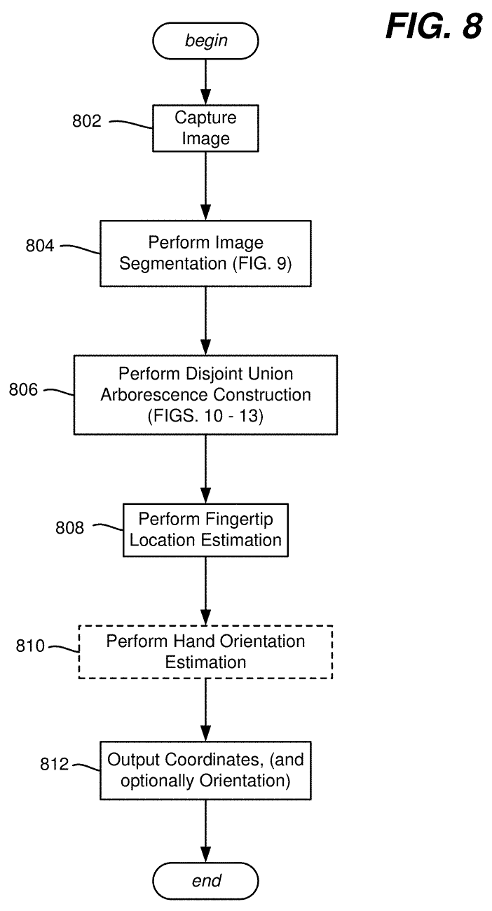

Turning to an explanation of an example implementation, FIG. 8 is a flow diagram showing general operations, exemplified as steps, including the above-described phases. Step 802 represents capturing the image that may include a pointed finger.

Step 804 represents the image segmentation phase, further described with reference to FIG. 9, beginning at step 902 where the captured image is converted to HSV space. For example, a camera resolution of 320 by 240 pixels is used in one implementation of fingertip detection, as it is suitable for the image segmentation process and reduces artifacts while maintaining performance. The color space conversion in Android is from YUV420sp to HSV, and may, for example, be implemented in C++ to perform the conversion in a single step for better performance (instead of first converting to BGR and then to HSV).

Step 904 represents clearing a binary image array, and step 906 selects the first pixel, e.g., having x- and y-coordinates of (0, 0). Step 908 evaluates whether the pixel meets the skin tone threshold. If so, step 910 writes a “1” value into the binary image array at the corresponding (0, 0) location, otherwise the value remains at “0”.

Steps 912 and 914 repeat the process for each other pixel until the binary image array is complete. Although not explicitly shown, it is understood that the evaluation of pixels may proceed in a top left corner to lower right corner direction, although any suitable direction may be used.

Returning to FIG. 8, step 806 represents performing disjoint union arborescence construction on the binary image array. Details of this phase are exemplified in the operations of FIG. 10, beginning at step 1002 where the first scanning window is selected, e.g., the leftmost topmost window, and a variable that indicates whether the currently selected window is in the last row of windows is set to false.

Step 1004 evaluates whether the currently selected window has been previously visited during the scan, which at this time is not true for the first window. Accordingly, step 1004 branches to step 1006 where equation (1) is evaluated, including that the pixel at the center of the currently selected window is a binary value equal to one. As described above, a filter of 10 by 10 pixels may be used to create the data structure of the extended disjoint union representation; where there is no exact center, the pixel considered to be the center may be approximated, e.g., the fifth pixel to the right and the fifth pixel down.

If equation (1) is not met, then step 1008 branches to step 1026 where the evaluation process is repeated on the next window to the right, and then the leftmost window in the next row down, until each window has been visited.

If equation (1) is met, then step 1008 branches to step 1010 where a node is added to the set, e.g., maintaining the pixel coordinates, the node's level and other information as described herein. The node's edge data will be updated during the recursive breadth first search as described herein.

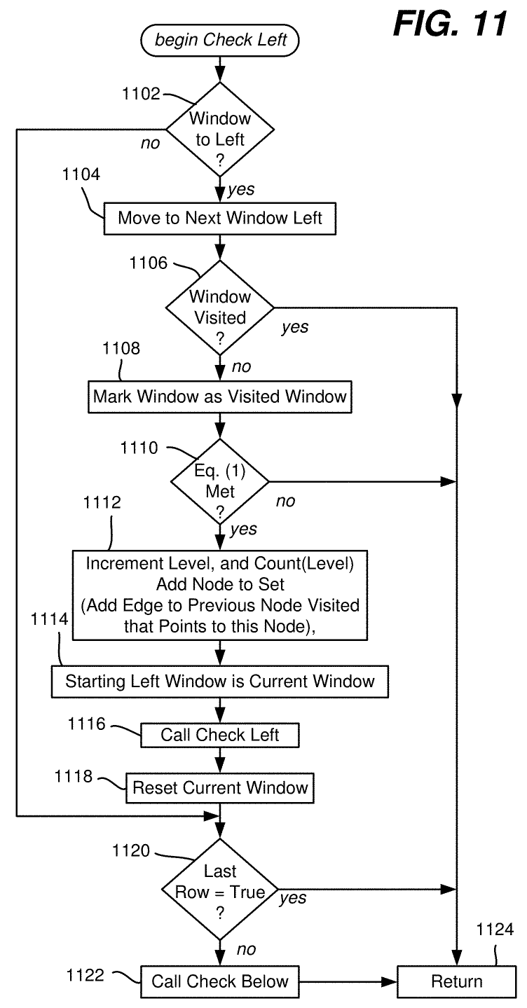

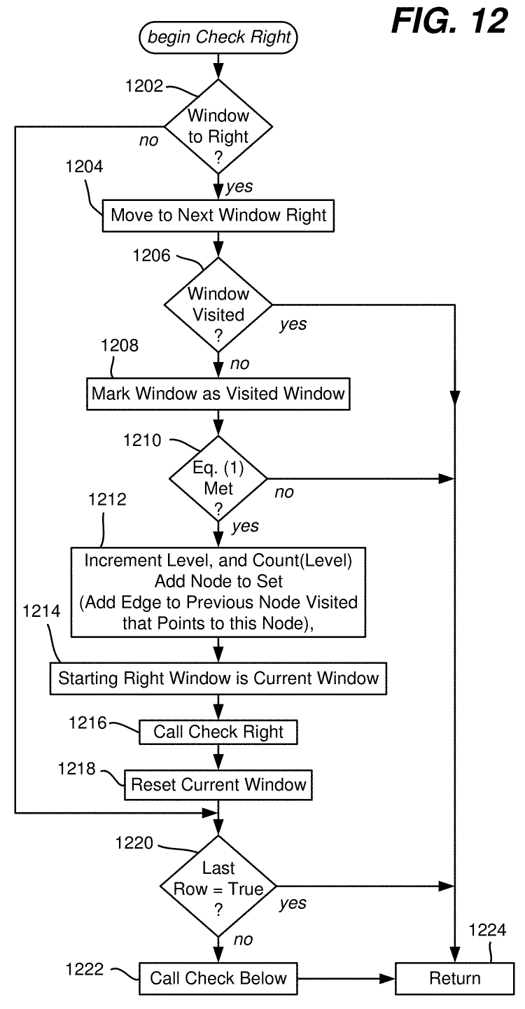

To perform the breadth first search, step 1014 calls a check left function (FIG. 11) at step 1014, resets the current window to its location before calling a check left function at step 1016, and calls a check right function (FIG. 12). In general and as described below, these calls, along with recursion, checks windows/nodes to the left and then windows/nodes to the right until a stopping condition is met in each direction.

Step 1020 resets the current window to its location before calling the check right function. If not the last row of windows, as evaluated at step 1022, step 1024 continues the breadth first search by calling a check below function at step 1024. Whether because the last row has been reached at step 1022 or after calling the check below function at step 1024, steps 1026-1030 repeat the process until each window has been visited either via the breadth first search or via step 1030.

FIG. 11 shows example operations in the form of steps for the check left function, beginning at step 1102 where the scanning process checks whether there is a window to the left, that is, the currently selected window is not already at the first column. If so, the check left function is complete; however the window below the currently selected window, if any, may need to be checked. Thus, step 1120 and 1122 are performed to check the window below the currently selected window, unless the currently selected window is already in the last row of windows (step 1120).

If a window to the left exists, step 1104 moves the currently selected window to the next window in the leftward direction, and step 1106 evaluates whether that window has already been visited. If so, the process returns. If not, step 1108 marks this window as visited.

Step 1110 evaluates whether equation (1) has been met for this new window, including that the center pixel has a binary value of one. If not met, the check left operations are over. If the criteria of equation (1) have been met, step 1112 increments a level value, as this node is below the window that called the check left function. Step 1112 adds the node to the set, and places an edge reference in the parent node to this node.

Step 1114 sets the starting left window to be the current window, and step 1116 recursively calls the check left function for this new current window. As can be readily appreciated, by recursion, the search continues in a leftward direction until the first column is reached (step 1102), an already visited window is reached (step 1106), or equation (1) is not met (step 1110).

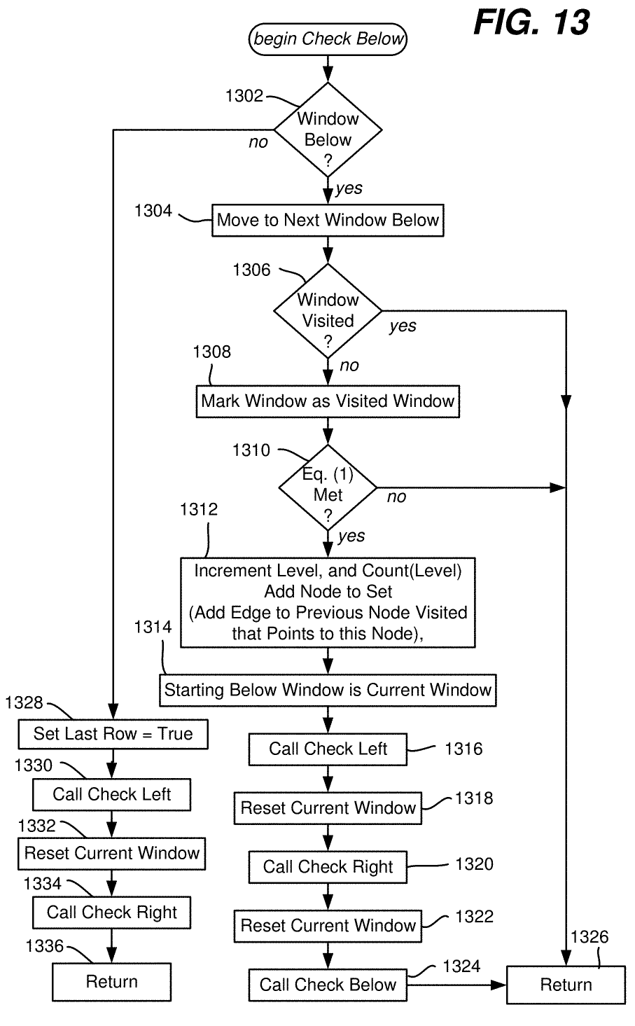

When the check left operations are done, step 1118 resets the current window to where it was before it was moved left. Step 1120 evaluates whether the window is in the last row of windows, and if not, calls the check below operation as described with reference to FIG. 13. The process then returns.

FIG. 12 shows example operations in the form of steps for the check right function, beginning at step 1202 where the scanning process checks whether there is a window to the right, that is, the currently selected window is not already at the last column. If so, the check right function is complete; however the window below the currently selected window, if any, may need to be checked. Thus, step 1220 and 1222 are performed to check the window below the currently selected window, unless the currently selected window is already in the last row of windows (step 1220).

If a window to the right exists, step 1204 moves the currently selected window to the next window in the rightward direction, and step 1206 evaluates whether that window has already been visited. If so, the process returns. If not, step 1208 marks this window as visited.

Step 1210 evaluates whether equation (1) has been met for this new window, including that the center pixel has a binary value of one. If not met, the check right operations are over. If the criteria of equation (1) have been met, step 1212 increments a level value, as this node is below (a child of) the window that called the check right function. Step 1212 adds the node to the set, and places an edge reference in the parent node to this node.

Step 1214 sets the starting right window to be the current window, and step 1216 recursively calls the check right function for this new current window. As can be readily appreciated, by recursion, the search continues in a rightward direction until the last column is reached (step 1202), an already visited window is reached (step 1206), or equation (1) is not met (step 1210).

When the check right operations are done, step 1218 resets the current window to where it was before it was moved right. Step 1220 evaluates whether the window is in the last row of windows, and if not, calls the check below operation as described with reference to FIG. 13. The process then returns.

FIG. 13 shows example operations in the form of steps for the check below function, beginning at step 1302 where the scanning process checks whether there is a window below, that is, the currently selected window is not already in the last row. If so, the check below function is complete and step 1328 sets the last row variable to be True at step 1328; however the window to the left and right of the currently selected window, if any, may need to be checked. Thus, steps 1330, 1332 and 1334 are performed (before returning at step 1336) to check the window or windows to the left and the right of the currently selected window, respectively. Note that the calls to the left function (step 1330) and the check right function (step 1334) may be recursive, but will not check below because the last row indicator variable is set to True.

If not at the last row, step 1302 branches to step 1304, which moves the currently selected window to the next window in the downward direction. Step 1306 evaluates whether that window has already been visited. If so, the process returns. If not, step 1308 marks this window as visited.

Step 1310 evaluates whether equation (1) has been met for this new window, including that the window's center pixel has a binary value of one. If not met, the check below operations are over and the check below process returns via step 1326. If instead the criteria of equation (1) have been met, step 1312 increments a level value, as this node is below (a child of) the window that called the check below function. Step 1312 also adds the node to the set, and places an edge reference in the parent node to this node.

Step 1314 sets the starting below window to be the current window, and step 1316 calls the check left function for this new current window. As can be readily appreciated, by recursion, the search continues in a leftward direction as described above. Steps of 1318 and 1320 perform the search in the rightward direction, and steps 1322 and 1324 recursively perform the search in the downward direction before returning at step 1326.

As can be seen, the technology enables mid-air freehand (barehanded) interaction with a wearable or other mobile device (e.g., smartglasses). The technology is able to utilize the camera available on the device, typically a monocular camera, to detect the fingertip location and corresponding gestural input and control. The technology provides a computationally efficient and energy efficient approach, with robust and real-time performance, and is easy-to-use in terms of improvement in task performance. The described technology that provides for intuitive human-smart glasses interaction, by only moving the fingertip directly to an appropriate location, has been successfully tested.

One or more aspects are directed towards processing, by a device comprising a processor, camera image data corresponding to a captured image comprising a hand with a pointed finger. The processing comprises performing image segmentation on the camera image data to obtain segmented image data that distinguishes pixels of the hand with the pointed finger from other pixels, and scanning the segmented image data using a sliding window, comprising using the sliding window at a current position to determine whether a first value of a pixel within the sliding window at the current position satisfies a selection criterion for the hand with the pointed finger. In response to the selection criterion being determined to be satisfied, aspects include adding a vertex node representing the pixel to a graph set and performing a search for one or more other nodes of the graph set related to the vertex node. In response to the selection criterion being determined not to be satisfied, and until each position of the sliding window is used, other aspects include using the sliding window at another position to determine whether a next value of a next pixel within the sliding window at the other position satisfies the selection criterion. Aspects include estimating a location of a fingertip of the hand with the pointed finger comprising identifying a selected graph from the graph set based on a number of nodes relative to other graphs in the graph set, and obtaining the location of the fingertip as a function of a root node of the selected graph.

Performing the image segmentation may comprise converting a device-based color space to a hue-saturation-value color model. Performing the image segmentation further may comprise outputting a binary value for each pixel of the pixels based on whether each pixel satisfies a skin tone criterion.

Scanning the segmented image data using the sliding window may comprise scanning the segmented image data from a top left of the captured image to a bottom right of the captured image, and performing the search may comprise performing a breadth-first search for the one or more nodes related to the vertex node by moving the sliding window to a new position on a same scan line towards the right and scanning the new position using the sliding window, and further moving the sliding window to another new position on a lower scan line than the same scan line and scanning the other new position using the sliding window.

Other aspects may include marking a depth value of each node, and updating groups of nodes respectively belonging to each depth level. Using the sliding window may comprise using a horizontal filter size value and a vertical filter size value to determine the other position of the sliding window.

Scanning the segmented image data using the sliding window may comprise marking each position of the sliding window, once used, as a visited sliding window position, and not re-using the visited sliding window position. Identifying the selected graph from the graph set based on the number of nodes relative to the other graphs in the graph set may comprise selecting a graph comprising a largest number of nodes relative to the other graphs. Scanning the segmented image data to determine whether the first value of the pixel within the sliding window satisfies the selection criterion may comprise evaluating a value of a center pixel or approximate center pixel of the sliding window.

Other aspects may include determining a hand orientation of the hand, comprising determining nodes of the graph set on a longest path from a root node in the graph set and determining a vector that connects the root node to the nodes on the longest path.

One or more aspects are directed towards image segmentation logic configured to process image data into binary image data, with each binary value of binary values represented by the binary image data representing whether or not a respective pixel meets a skin tone threshold value criterion. Graph construction logic is configured to process the binary image data into a plurality of graphs, to move a sliding window to locate matching pixels that meet the skin tone threshold value criterion, and to store root graph nodes and lower-level nodes of the root graph nodes corresponding to the matching pixels in the plurality of graphs, with each node of the graph nodes and the low-level nodes representing pixel coordinates of a corresponding pixel of the matching pixels and a depth level value of the node. Fingertip location estimation logic is configured to select a graph from the plurality of graphs, wherein the graph that is selected that has a largest number of nodes relative to other graphs of the plurality of graphs, and wherein the fingertip location estimation logic is further configured to use root node coordinates of a root node of the graph to estimate a location of a fingertip within the image data.

The plurality of graphs may comprise a set of arborescence graphs. The graph construction logic may be further configured to maintain values representing respective numbers of nodes at different given depths represented by respective depth level values of the graph nodes.

The image segmentation logic, the graph construction logic, and the fingertip location estimation logic may be incorporated into a smart glasses device. The smart glasses device further may comprise a device camera that captures the image data.

One or more implementations may comprise hand orientation determination logic configured to determine orientation of a hand associated with the fingertip based on choosing as chosen nodes the nodes on the longest path from the root node corresponding to the fingertip location, and finding a vector that connects the root node to the chosen nodes.

One or more aspects are directed towards performing image segmentation on camera image data, representative of a hand and a fingertip of the hand, to generate binary image data comprising binary values representative of whether or not respective pixels in the camera image data satisfy a skin tone criterion. Aspects include generating arborescence graphs, comprising scanning the binary image data using non-visited sliding windows, comprising using a selected pixel in a sliding window of the non-visited sliding windows to determine whether a binary value of the binary values corresponding to the selected pixel indicates that the selected pixel satisfies the skin tone criterion and marking the sliding window as visited. In response to the binary value of the selected pixel indicating that the selected pixel satisfies the skin tone criterion, described herein is adding a vertex node for a graph to the arborescence graphs and performing a search for one or more nodes related to the vertex node by moving the sliding window to a next sliding window of the non-visited sliding windows, and until each sliding window of the non-visited sliding windows has been visited, further scanning the binary image data, adding another vertex node where the skin tone criterion is satisfied for a next selected pixel and performing another search for one or more other nodes related to the other vertex node. Aspects comprise estimating a location of the fingertip of the hand comprising selecting a graph from the arborescence graphs based on a number of nodes relative to other graphs in the arborescence graphs, and determining the location of the fingertip based on information represented in a root node of the graph.

Other aspects may comprise, for each sliding window of the non-visited sliding windows, choosing a center pixel of the sliding window as the selected pixel.

Moving the moving the sliding window may comprise, changing coordinates corresponding to a horizontal position and a vertical position of a candidate sliding window of the non-visited sliding windows based on one or more filter values, and determining whether the candidate sliding window has been marked as visited.

Other aspects may comprise determining an orientation of the hand, comprising choosing nodes on a longest path from a root node in the graph and finding a vector that connects the root node to the nodes on the longest path.

### Example Environment

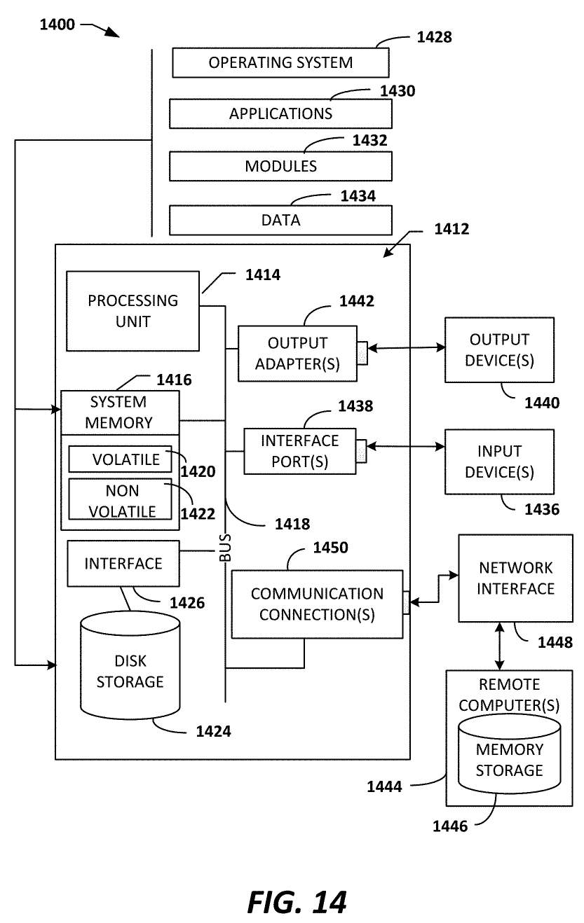

The techniques described herein can be applied to any device or set of devices (machines) capable of running programs and processes. It can be understood, therefore, that wearable devices, mobile devices such as smart glasses, servers including physical and/or virtual machines, personal computers, laptops, handheld, portable and other computing devices and computing objects of all kinds including cell phones, tablet/slate computers, gaming/entertainment consoles and the like are contemplated for use in connection with various implementations including those exemplified herein. Accordingly, the general purpose computing mechanism described below with reference to FIG. 14 is but one example of a computing device.

In order to provide a context for the various aspects of the disclosed subject matter, FIG. 14 and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules include routines, programs, components, data structures, etc. that perform particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory, by way of illustration, and not limitation, volatile memory 1420, non-volatile memory 1422, disk storage 1424, solid-state memory devices, and memory storage 1446. Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, including single-processor or multiprocessor computer systems, mini-computing devices, mainframe computers, as well as personal computers, hand-held computing devices (e.g., PDA, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 14 illustrates a block diagram of a computing system 1400, e.g., built into a smart glasses device, operable to execute the disclosed systems and methods in accordance with an embodiment. Computer 1412, which can be, for example, part of the hardware of system 1400, includes a processing unit 1414, a system memory 1416, and a system bus 1418. System bus 1418 couples system components including, but not limited to, system memory 1416 to processing unit 1414. Processing unit 1414 can be any of various available processors. Dual microprocessors and other multiprocessor architectures also can be employed as processing unit 1414.

System bus 1418 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics , VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1494), and Small Computer Systems Interface (SCSI).

System memory 1416 can include volatile memory 1420 and nonvolatile memory 1422. A basic input/output system (BIOS), containing routines to transfer information between elements within computer 1412, such as during start-up, can be stored in nonvolatile memory 1422. By way of illustration, and not limitation, nonvolatile memory 1422 can include ROM, PROM, EPROM, EEPROM, or flash memory. Volatile memory 1420 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1412 can also include removable/non-removable, volatile/non-volatile computer storage media. FIG. 14 illustrates, for example, disk storage 1424. Disk storage 1424 includes, but is not limited to, devices like a magnetic disk drive, floppy disk drive, tape drive, flash memory card, or memory stick. In addition, disk storage 1424 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1424 to system bus 1418, a removable or non-removable interface is typically used, such as interface 1426.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD ROM, digital versatile disk (DVD) or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can include non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. For the avoidance of doubt, the term “computer-readable storage device” is used and defined herein to exclude transitory media. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

It can be noted that FIG. 14 describes software that acts as an intermediary between users and computer resources described in suitable operating environment 1400. Such software includes an operating system 1428. Operating system 1428, which can be stored on disk storage 1424, acts to control and allocate resources of computer system 1412. System applications 1430 take advantage of the management of resources by operating system 1428 through program modules 1432 and program data 1434 stored either in system memory 1416 or on disk storage 1424. It is to be noted that the disclosed subject matter can be implemented with various operating systems or combinations of operating systems.

A user can enter commands or information into computer 1412 through input device(s) 1436, including via fingertip pointing as described herein. As an example, mobile device 142 and/or portable device 144 can include a user interface embodied in a touch sensitive display panel allowing a user to interact with computer 1412. Input devices 1436 include, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1414 through system bus 1418 by way of interface port(s) 1438. Interface port(s) 1438 include, for example, a serial port, a parallel port, a game port, a universal serial bus (USB), an infrared port, a Bluetooth port, an IP port, or a logical port associated with a wireless service, etc. Output device(s) 1440 use some of the same type of ports as input device(s) 1436.

Thus, for example, a USB port can be used to provide input to computer 1412 and to output information from computer 1412 to an output device 1440. Output adapter 1442 is provided to illustrate that there are some output devices 1440 like monitors, speakers, and printers, among other output devices 1440, which use special adapters. Output adapters 1442 include, by way of illustration and not limitation, video and sound cards that provide means of connection between output device 1440 and system bus 1418. It should be noted that other devices and/or systems of devices provide both input and output capabilities such as remote computer(s) 1444.

Computer 1412 can operate in a networked environment using logical connections to one or more remote computers, such as remote computer(s) 1444. Remote computer(s) 1444 can be a personal computer, a server, a router, a network PC, cloud storage, cloud service, a workstation, a microprocessor based appliance, a peer device, or other common network node and the like, and typically includes many or all of the elements described relative to computer 1412.

For purposes of brevity, only a memory storage device 1446 is illustrated with remote computer(s) 1444. Remote computer(s) 1444 is logically connected to computer 1412 through a network interface 1448 and then physically connected by way of communication connection 1450. Network interface 1448 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit-switching networks like Integrated Services Digital Networks (ISDN) and variations thereon, packet switching networks, and Digital Subscriber Lines (DSL). As noted below, wireless technologies may be used in addition to or in place of the foregoing.

Communication connection(s) 1450 refer(s) to hardware/software employed to connect network interface 1448 to bus 1418. While communication connection 1450 is shown for illustrative clarity inside computer 1412, it can also be external to computer 1412. The hardware/software for connection to network interface 1448 can include, for example, internal and external technologies such as modems, including regular telephone grade modems, cable modems and DSL modems, ISDN adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media, device readable storage devices, or machine readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

### Conclusion

While the invention is susceptible to various modifications and alternative constructions, certain illustrated implementations thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various implementations described herein, it is to be understood that other similar implementations can be used or modifications and additions can be made to the described implementation(s) for performing the same or equivalent function of the corresponding implementation(s) without deviating therefrom. Accordingly, the invention is not to be limited to any single implementation, but rather is to be construed in breadth, spirit and scope in accordance with the appended claims.

What is claimed is:

1. A method, comprising:
processing, by a device comprising a processor, camera image data corresponding to a captured image comprising a hand with a pointed finger, the processing comprising:
performing image segmentation on the camera image data to obtain segmented image data that distinguishes pixels of the hand with the pointed finger from other pixels;
scanning the segmented image data using a sliding window, comprising using the sliding window at a current position to determine whether a first value of a pixel within the sliding window at the current position satisfies a selection criterion for the hand with the pointed finger;
in response to the selection criterion being determined to be satisfied, adding a vertex node representing the pixel to a graph set and performing a search for one or more other nodes of the graph set related to the vertex node;
in response to the selection criterion being determined not to be satisfied, and until each position of the sliding window is used, using the sliding window at another position to determine whether a next value of a next pixel within the sliding window at the other position satisfies the selection criterion; and
estimating a location of a fingertip of the hand with the pointed finger comprising identifying a selected graph from the graph set based on a number of nodes relative to other graphs in the graph set, and obtaining the location of the fingertip as a function of a root node of the selected graph.

2. The method of claim 1, wherein the performing the image segmentation comprises converting a device-based color space to a hue-saturation-value color model.

3. The method of claim 2, wherein the performing the image segmentation further comprises outputting a binary value for each pixel of the pixels based on whether each pixel satisfies a skin tone criterion.

4. The method of claim 1, wherein the scanning the segmented image data using the sliding window comprises scanning the segmented image data from a top left of the captured image to a bottom right of the captured image, and wherein the performing the search comprises performing a breadth-first search for the one or more nodes related to the vertex node by moving the sliding window to a new position on a same scan line towards the right and scanning the new position using the sliding window, and further moving the sliding window to another new position on a lower scan line than the same scan line and scanning the other new position using the sliding window.

5. The method of claim 1, further comprising, marking a depth value of each node, and updating groups of nodes respectively belonging to each depth level.

6. The method of claim 1, wherein the using the sliding window comprises using a horizontal filter size value and a vertical filter size value to determine the other position of the sliding window.

7. The method of claim 1, wherein the scanning the segmented image data using the sliding window comprises marking each position of the sliding window, once used, as a visited sliding window position, and not re-using the visited sliding window position.

8. The method of claim 1, wherein the identifying the selected graph from the graph set based on the number of nodes relative to the other graphs in the graph set comprises selecting a graph comprising a largest number of nodes relative to the other graphs.

9. The method of claim 1, wherein the scanning the segmented image data to determine whether the first value of the pixel within the sliding window satisfies the selection criterion comprises evaluating a value of a center pixel or approximate center pixel of the sliding window.

10. The method of claim 1, further comprising, determining a hand orientation of the hand, comprising determining nodes of the graph set on a longest path from a root node in the graph set and determining a vector that connects the root node to the nodes on the longest path.

11. A system, comprising:
image segmentation logic configured to process image data into binary image data, with each binary value of binary values represented by the binary image data representing whether or not a respective pixel meets a skin tone threshold value criterion;
graph construction logic configured to process the binary image data into a plurality of graphs, to move a sliding window to locate matching pixels that meet the skin tone threshold value criterion, and to store root graph nodes and lower-level nodes of the root graph nodes corresponding to the matching pixels in the plurality of graphs, with each node of the graph nodes and the low-level nodes representing pixel coordinates of a corresponding pixel of the matching pixels and a depth level value of the node; and
fingertip location estimation logic configured to select a graph from the plurality of graphs, wherein the graph that is selected that has a largest number of nodes relative to other graphs of the plurality of graphs, and wherein the fingertip location estimation logic is further configured to use root node coordinates of a root node of the graph to estimate a location of a fingertip within the image data.

12. The system of claim 11, wherein the plurality of graphs comprises a set of arborescence graphs.

13. The system of claim 11, wherein the graph construction logic is further configured to maintain values representing respective numbers of nodes at different given depths represented by respective depth level values of the graph nodes.

14. The system of claim 11, wherein the image segmentation logic, the graph construction logic, and the fingertip location estimation logic are incorporated into a smart glasses device.

15. The system of claim 14, wherein the smart glasses device further comprises a device camera that captures the image data.

16. The system of claim 11, further comprising, hand orientation determination logic configured to determine orientation of a hand associated with the fingertip based on choosing as chosen nodes the nodes on the longest path from the root node corresponding to the fingertip location, and finding a vector that connects the root node to the chosen nodes.

17. A machine-readable storage medium, comprising executable instructions that, when executed by a processor, facilitate performance of operations, comprising:
performing image segmentation on camera image data, representative of a hand and a fingertip of the hand, to generate binary image data comprising binary values representative of whether or not respective pixels in the camera image data satisfy a skin tone criterion;
generating arborescence graphs, comprising scanning the binary image data using non-visited sliding windows, comprising using a selected pixel in a sliding window of the non-visited sliding windows to determine whether a binary value of the binary values corresponding to the selected pixel indicates that the selected pixel satisfies the skin tone criterion and marking the sliding window as visited;
in response to the binary value of the selected pixel indicating that the selected pixel satisfies the skin tone criterion, adding a vertex node for a graph to the arborescence graphs and performing a search for one or more nodes related to the vertex node by moving the sliding window to a next sliding window of the non-visited sliding windows, and until each sliding window of the non-visited sliding windows has been visited, further scanning the binary image data, adding another vertex node where the skin tone criterion is satisfied for a next selected pixel and performing another search for one or more other nodes related to the other vertex node; and
estimating a location of the fingertip of the hand comprising selecting a graph from the arborescence graphs based on a number of nodes relative to other graphs in the arborescence graphs, and determining the location of the fingertip based on information represented in a root node of the graph.

18. The machine-readable storage medium of claim 17, wherein the operations further comprise, for each sliding window of the non-visited sliding windows, choosing a center pixel of the sliding window as the selected pixel.

19. The machine-readable storage medium of claim 17, wherein the moving the sliding window comprises, changing coordinates corresponding to a horizontal position and a vertical position of a candidate sliding window of the non-visited sliding windows based on one or more filter values, and determining whether the candidate sliding window has been marked as visited.

20. The machine-readable storage medium of claim 17, wherein the operations further comprise determining an orientation of the hand, comprising choosing nodes on a longest path from a root node in the graph and finding a vector that connects the root node to the nodes on the longest path.
